(19) United States
(12) Patent Application Publication
(10) Pub. No.: US 2012/0063331 A1
(43) Pub. Date: Mar. 15, 2012

(54) PATH ANALYZER

(75) Inventor: Hideaki MIYAZAKI, Kobe (JP)

(73) Assignee: Fujitsu Limited

(21) Appl. No.: 13/230,332

(22) Filed: Sep. 12, 2011

Related U.S. Application Data
(63) Continuation of application No. PCT/JP2009/055305, filed on Mar. 19, 2009.

(51) Int. Cl. H04L 12/26

(52) U.S. Cl. 370/248

(57) ABSTRACT

A path analyzer to obtain an address of a relay node on a path between a first terminal device and a second terminal device includes: a first address obtaining unit to issue a command requiring a response from the first terminal device to the second terminal device and to obtain as a first address an address of a first terminal device side in the relay node on the path; a broadcast processing unit to search a candidate address for a broadcast address from the relay node according to the first address obtained and to issue a command requiring a response from the first terminal device to the candidate address; and a second address obtaining unit to obtain as a second address an address of a second terminal device side in the relay node on the path according to a response to the command issued by the broadcast processing unit.

### CROSS-REFERENCE TO RELATED APPLICATION

This application is a continuation application of International PCT Application No. PCT/JP2009/055305, which was filed on Mar. 18, 2009, the entire contents of which are incorporated herein by reference.

### FIELD

The embodiments discussed herein are related to a path analyzer that obtains a relay path between terminals in the IP network.

### BACKGROUND

Conventionally, IP networks using an internet protocol have become widespread, and IP telephones have also been realized. In IP networks, quality deterioration failures such as disruption, packet loss, or increased communication delay sometimes occur due to setting errors or faults of a relay device (relay node) between terminals. In IP networks, generally, what relay node the communication path between terminals goes through is dynamically determined. In order to instantly specify and recover the failed portion when a failure occurs as described above, it is preferable for a network administrator to be able to obtain a communication path between the terminals.

Conventionally, for example, the following two systems of obtaining a communication path are known.

The first system is a system that uses a traceroute command (for example, see Japanese Laid-open Patent Publication No. 2000-278320, Japanese Laid-open Patent Publication No. 2002-111665, Japanese Patent No. 3842624, and Japanese Patent No. 3141852). A traceroute command is a kind of measurement packet that uses an ICMP (Internet Control Message Protocol) or the like, and is transmitted from one terminal to a specified destination terminal. A measurement packet includes a parameter called TTL (Time To Live). A parameter TTL indicates the survival time of a packet. A parameter TTL has “1” subtracted from it every time the parameter TTL passes a node, and a response is given back to the source when the parameter TTL becomes “0”. In other words, as illustrated in FIG. 13, when a traceroute command is transmitted from a terminal T1 to the destination terminal of terminal T2 and if “TTL=1”, only the address of a node n1 on a path between the terminal T1 and the terminal T2 will be obtained. If “TTL=2”, the address of a node n2 will be obtained. In a similar manner, if “TTL=3”, the address of a node n3 will be obtained, and if “TTL=4”, the address of the terminal T2 will be obtained. As described above, by transmitting traceroute commands and sequentially increasing the value of parameter TTL from “1”, the first, second . . . node addresses before the terminal on the other end will be sequentially obtained.

The second system is a system that obtains a MIB (Management Information Base) of a relay node. A MIB includes the information of a relay node and the information of an interface and routing. A MIB is obtained by issuing an SNMP (Simple Network Management Protocol) to the address obtained by using a traceroute command as above. By analyzing such a MIB, it is possible to know from what relay node to what relay node a packet flows.

### SUMMARY

According to an aspect of the invention, a path analyzer to obtain an address of a relay node on a path between a first terminal device and a second terminal device includes: a first address obtaining unit to issue a command requiring a response from the first terminal device to the second terminal device, and to obtain as a first address an address of a first terminal device side in the relay node on the path according to a response to the command; a broadcast processing unit to search a candidate address for a broadcast address from the relay node according to the first address obtained by the first address obtaining unit, and to issue a command requiring a response from the first terminal device to the candidate address; and a second address obtaining unit to obtain as a second address an address of a second terminal device side in the relay node on the path according to a response to the command issued by the broadcast processing unit.

The object and advantage of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a schematic configuration of a terminal device according to the first embodiment.

FIG. 2 is a block diagram illustrating an example network configuration between a terminal device 1 and a terminal device 2.

FIG. 3 is a flowchart illustrating the operations of a terminal device 1 according to the first embodiment.

FIG. 4 is a flowchart illustrating the processing executed by a node back-address obtaining unit 102 in Op103 of FIG. 3.

FIG. 5 is a diagram illustrating an example back address determined by a node back-address obtaining unit 102 according to a front address obtained in Op101 and Op102.

FIG. 6 is a block diagram illustrating a schematic configuration of a terminal device according to the second embodiment.

FIG. 7 is a flowchart illustrating the operations of a terminal device according to the second embodiment.

FIG. 8 is a block diagram illustrating a schematic configuration of a terminal device according to the third embodiment.

FIG. 9 is a flowchart illustrating the operations of a terminal device according to the third embodiment.

FIG. 10 is a diagram illustrating an example of the front addresses and back addresses of each relay node in an upstream direction from a terminal device 1 to a terminal device 2.

FIG. 11 is a diagram illustrating example response times at the front addresses and back addresses of each relay node.

FIG. 12 is a diagram illustrating example differences in response time between adjacent addresses.

FIG. 13 is a schematic diagram illustrating a system of obtaining an address of a relay node by using a traceroute command in the conventional IP network.

FIG. 14 is a schematic diagram illustrating how one relay node has addresses of a front side and a back side.

### DESCRIPTION OF EMBODIMENTS

According to the above-described conventional system, it is possible to obtain the front address of a relay node. However, it has been difficult to obtain the back address. Assuming a relay node on a communication path from a first terminal to a second terminal, the term “front address” indicates the address of the interface that receives a command of the first terminal from the first terminal or the relay node in the upstream area. The term “back address” of the relay node indicates the address of the interface that outputs a command from the relay node to the relay node in the downstream area.

Here, the reason it is difficult to obtain the back address of a relay node according to the conventional systems will be described.

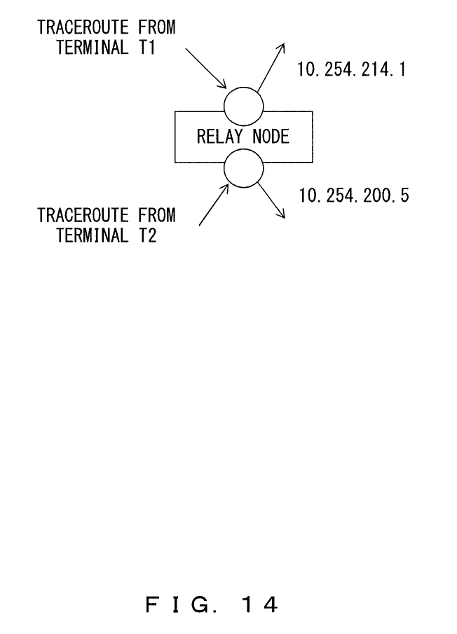

As illustrated in FIG. 14, when there are several interfaces with a link (subnet) that is connected to a relay node, the relay node has a unique address for each interface. In other words, it is ordinary for a relay node to have two or more addresses. Moreover, when a traceroute command is received, each relay node returns the address corresponding to the link by which a traceroute command is transmitted to the relay node. In the example of FIG. 14, if a traceroute command is received from the terminal T1, the address “10.254.214.1” is returned. On the other hand, if a traceroute command is received from the terminal T2, the address “10.254.200.5” is returned. That is, in the example of FIG. 14, the front address is “10.254.214.1”, and the back address is “10.254.200.5”, as viewed from the terminal T1.

If the path in upstream direction matches the path in downstream direction between the terminal T1 and the terminal T2, it is possible to obtain the front address by issuing a traceroute command from the terminal T1 to the terminal T2, and it is also possible to obtain the back address as viewed from the terminal T1 by issuing a traceroute command from the terminal T2 to the terminal T1. Assuming that one terminal device communicates to another terminal device, the term “upstream direction” indicates the outward direction of the communication, and the term “downstream direction” indicates the returning direction of the communication. If the path in upstream direction does not match the path in downstream direction between the terminal T1 and the terminal T2, for example regarding the node that becomes a relay node only in the upstream direction, it is not possible to obtain the back address as viewed from the terminal T1 even if a traceroute command is issued from the terminal T2.

When the conventional second system, i.e., a MIB, is used, there are problems wherein the information of a relay node in the network outside the control cannot be obtained, and wherein the routing information of all the interfaces of a relay node need to be searched for, which consumes time for analysis.

A path analyzer according to one aspect of the present invention obtains an address of a relay node in a path between a first terminal device and a second terminal device, and the path analyzer includes: a first address obtaining unit to issue a command requiring a response from the first terminal device to the second terminal device and to obtain an address of a first terminal device side in the relay node on the path as a first address according to a response to the command; a broadcast processing unit to search a candidate address for a broadcast address from the relay node according to the first address obtained by the first address obtaining unit and to issue a command requiring a response from the first terminal device to the candidate address; and a second address obtaining unit to obtain an address of a second terminal device side in the relay node on the path as a second address according to a response to the command issued by the broadcast processing unit (first configuration). A path analyzer according to the first configuration may be implemented in an integrated state in a terminal device, or may be implemented as a different device other than a terminal device.

According to the first configuration, due to a first address obtaining unit, an address of a first terminal device side in the relay node on the path between the first and second terminal devices can be obtained as a first address. Further, a candidate address for a broadcast address from the relay node is searched according to the first address, and an address of a second terminal device side in the relay node on the path is obtained by the second address obtaining unit as a second address according to a response to the command issued to a candidate address. Accordingly, it is possible to obtain a plurality of addresses of a relay node (front address and back address).

It is preferable for a path analyzer according to the above-described first configuration to further include: a third address obtaining unit to issue a command requiring a response from the second terminal device to the first terminal device and to obtain an address of a second terminal device side in the relay node on a path from the first terminal device to the second terminal device as a third address according to a response to the command; a common-node determination unit to compare the second address obtained by the second address obtaining unit with the third address obtained by the third address obtaining unit to determine a common relay node between a path from the first terminal device to the second terminal device and a path from the second terminal device to the first terminal device; and a path determination unit to determine, according to a determination result of the common-node determination unit, a section passing through mutually different relay nodes between a path from the first terminal device to the second terminal device and a path from the second terminal device to the first terminal device (second configuration).

According to the second configuration, a common-node determination unit compares the second address obtained by the second address obtaining unit with the third address obtained by the third address obtaining unit to determine a common relay node. Moreover, a path determination unit calculates a section passing through mutually different relay nodes between a path from the first terminal device to the second terminal device and a path from the second terminal device to the first terminal device. Accordingly, it is possible to determine whether a path from the first terminal device to the second terminal device and a path from the second terminal device to the first terminal device are different from each other or the same.

In a path analyzer according to the above-described second configuration, it is preferable for the common-node determination unit to simultaneously issues a command requiring a response to each of two addresses that belong to a combination estimated to be addresses of a same node from among combinations of the second address and the third address and to determine whether or not the two addresses are addresses of a same node according to a status of response to the command (third configuration).

According to the third configuration, it is possible to determine whether or not the two addresses are addresses of a same node according to a status of response to the command. As a status of response to the command, time stamp information or the like may be used in addition to the time required for a response.

It is preferable for a path analyzer according to the above-described second or third configuration to further include: a network failure detection unit to detect that a network failure has been caused between the first terminal device and the second terminal device; and a network failure occurrence portion specifying unit to determine that a network failure has been caused at a section determined by the path determination unit as a section passing through mutually different relay nodes when the network failure detection unit detects that a network failure has been caused in either communication from the first terminal device to the second terminal device or communication from the second terminal device to the first terminal device (fourth configuration).

According to the fourth configuration, it is possible to specify a portion at which a network failure has been caused when a network failure is caused in either communication from the first terminal device to the second terminal device or communication from the second terminal device to the first terminal device.

It is preferable for a path analyzer according to the above-described first through fourth configurations to further include a failed section detection unit to issue a command requiring a response to the first address obtained by the first address obtaining unit and to the second address obtained by the second address obtaining unit, respectively, and to calculate a difference in response time to the command for a combination of two addresses neighboring on the path from among the first and second address, and to determine that a failure has been caused between two addresses included in a combination from which a largest difference is calculated (fifth configuration).

According to the fifth configuration, it is possible to calculate a difference in response time among a plurality of addresses of one relay node, and thus even when a failure has been caused not only between relay nodes but also in an apparatus of a relay node, it is possible to detect the failure by using the calculated difference.

The present invention may be implemented as a program or a method in addition to the implementation as an apparatus.

More specific embodiments of the present invention will be described with reference to the accompanying drawings.

### First Embodiment

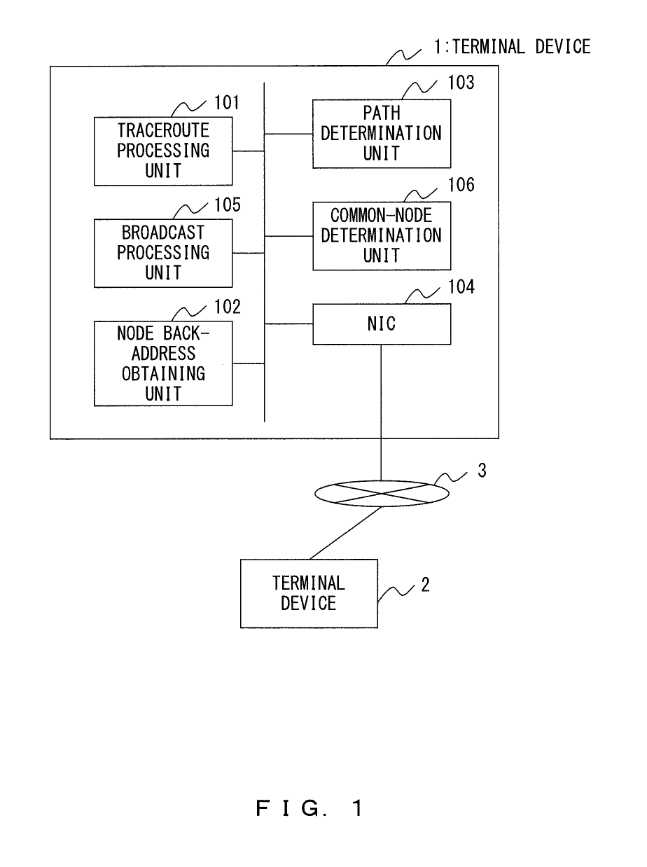

The first embodiments of the present invention will be described in detail. FIG. 1 is a block diagram illustrating a schematic configuration of a terminal device according to the first embodiment. FIG. 1 only illustrates primary functional blocks that relate to the path analysis from among the functions of a terminal device, and the illustration and explanation of known functions of a terminal device will be omitted. In other words, an actual terminal device may involve various functions other than the ones illustrated in FIG. 1. In the first embodiment, an example configuration is described in which a terminal device 1 functions also as a path analyzer. It is to be noted that a system may be configured such that all the terminal devices on the network have the same configuration as the terminal device 1 to execute the same operations, but it is not always necessary for all the terminal devices to have the functions of a path analyzer. Alternatively, it is also a possible configuration for the functions of a path analyzer to be provided to a different device other than a terminal device (for example, a communication control device or a network monitoring device).

As illustrated in FIG. 1, the terminal device 1 according to the present embodiment communicates with another terminal device via a network 3. The network 3 is an IP network that can communicate by using an internet protocol. In FIG. 1, one of the terminals with which the terminal device 1 communicates is illustrated as a terminal device 2. It is to be noted that other terminal devices are connected to the network 3, and the terminal device 1 may communicate with other terminal devices other than the terminal device 2.

The terminal device 1 is provided with a traceroute processing unit 101 (first address obtaining unit, third address obtaining unit), a node back-address obtaining unit 102 (second address obtaining unit), a path determination unit 103, a network interface card (hereinafter, referred to as “NIC”) 104, a broadcast processing unit 105, and a common-node determination unit 106. In the terminal device 1, the traceroute processing unit 101, the node back-address obtaining unit 102, the path determination unit 103, the broadcast processing unit 105, and the common-node determination unit 106 are functional processing blocks realized as a CPU of the terminal device 1 which executes a program stored in a storage device of the terminal device 1. Accordingly, the hardware corresponding respectively to the traceroute processing unit 101, node back-address obtaining unit 102, path determination unit 103, broadcast processing unit 105, and common-node determination unit 106 does not necessarily exist in the terminal device 1. However, it is still possible to implement the blocks as a separate hardware circuitry.

The traceroute processing unit 101 issues a traceroute command, and thereby obtains the addresses of a relay node and a terminal on the other end. In the present embodiment, the traceroute processing unit 101 of the terminal device 1 issues a traceroute command from the terminal device 1 to the terminal device 2, and thereby obtains an address of a terminal device 1 side (first address) of the relay node which exists on the communication path from the terminal device 1 to the terminal device 2. Further, in the present embodiment, the traceroute processing unit 101 of the terminal device 1 instructs the terminal device 2 to issue a traceroute command from the terminal device 2 to the terminal device 1, and thereby obtains an address of a terminal device 2 side (third address) of the relay node which exists on the communication path from the terminal device 2 to the terminal device 1.

The broadcast processing unit 105 determines a candidate for a broadcast address from each relay node according to the address obtained by the traceroute processing unit 101. The node back-address obtaining unit 102 issues a command such as a ping command to a candidate for a broadcast address which is determined by the broadcast processing unit 105. The node back-address obtaining unit 102 obtains a back address of a relay node (second address) according to a response to the command issued by the broadcast processing unit 105.

The common-node determination unit 106 compares the above-described third address obtained by the traceroute processing unit 101 with the above-described second address obtained by the broadcast processing unit 105, and thereby determines a relay node that is in common between a path from the terminal device 1 to the terminal device 2 and the reverse path from the terminal device 2 to the terminal device 1.

The path determination unit 103 compares a processing result of the traceroute processing unit 101 with a processing result of the node back-address obtaining unit 102, and thereby determines whether or not there is a section passing through mutually different relay nodes on the path for upstream direction and the path for downstream direction between the terminal device 1 and the terminal device 2.

If the terminal device 2 does not require the functions of a path analyzer, the terminal device 2 only requires the traceroute processing unit 101 and the NIC 104, and the terminal device 2 may not be provided with the node back-address obtaining unit 102, the path determination unit 103, the broadcast processing unit 105, and the common-node determination unit 106.

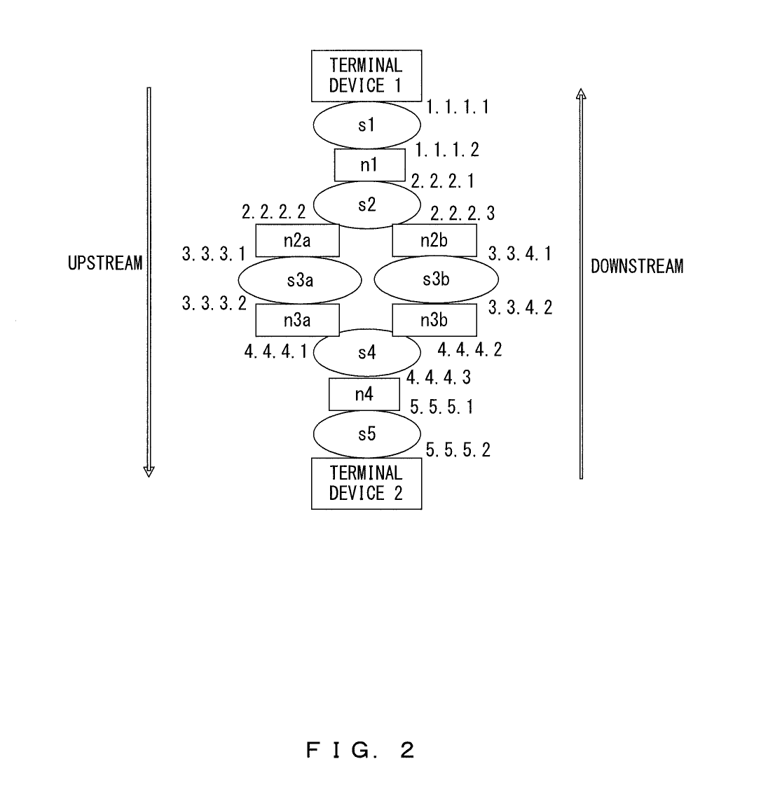

The operations of a terminal device according to the first embodiment will be described in detail with reference to some specific examples. FIG. 2 is a block diagram illustrating an example network configuration between the terminal device 1 and the terminal device 2. In the example of FIG. 2, there are a node n1, a node n2a, a node n2b, a node n3a, a node n3b, and a node n4 as relay nodes between the terminal device 1 and the terminal device 2.

The terminal device 1 is connected to a subnet s1, where the address is “1.1.1.1”. The terminal device 2 is connected to a subnet s5, where the address is “5.5.5.2”. The node n1 is connected to two subnets s1 and s2, where the address on the subnet s1 side is “1.1.1.2” and the address on the subnet s2 side is “2.2.2.1”. The node n2a is connected to two subnets s2 and s3a, where the address on the subnet s2 side is “2.2.2.2” and the address on the subnet s3a side is “3.3.3.1”. The node n2b is connected to two subnets s2 and s3b, where the address on the subnet s2 side is “2.2.2.3” and the address on the subnet s3b side is “3.3.4.1”. The node n3a is connected to two subnets s3a and s4, where the address on the subnet s3a side is “3.3.3.2” and the address on the subnet s4 side is “4.4.4.1”. The node n3b is connected to two subnets s3b and s4, where the address on the subnet s3b side is “3.3.4.2” and the address on the subnet s4 side is “4.4.4.2”. The node n4 is connected to two subnets s4 and s5, where the address on the subnet s4 side is “4.4.4.3” and the address on the subnet s5 side is “5.5.5.1”. Moreover, it is assumed that the transmission path from the terminal device 1 to the terminal device 2 (i.e., upstream path as viewed from the terminal device 1) is set in the order of “terminal device 1->node n1->node n2a->node n3a->node n4->terminal device 2”, and that the transmission path from the terminal device 2 to the terminal device 1 (i.e., downstream path as viewed from the terminal device 1) is set in the order of “terminal device 2->node n4->node n3b->node n2b->node n1->terminal device 1”. The operations will be described below under the premise of the above-described network configuration.

The front addresses of nodes indicate the addresses given to the interfaces on the upstream side of a communication path as viewed from a specific terminal, and the back addresses indicate the addresses given to the interfaces on the downstream side. For example, the front address of the node n1 as viewed from the terminal 1 is “1.1.1.2” and the back address is “2.2.2.1”.

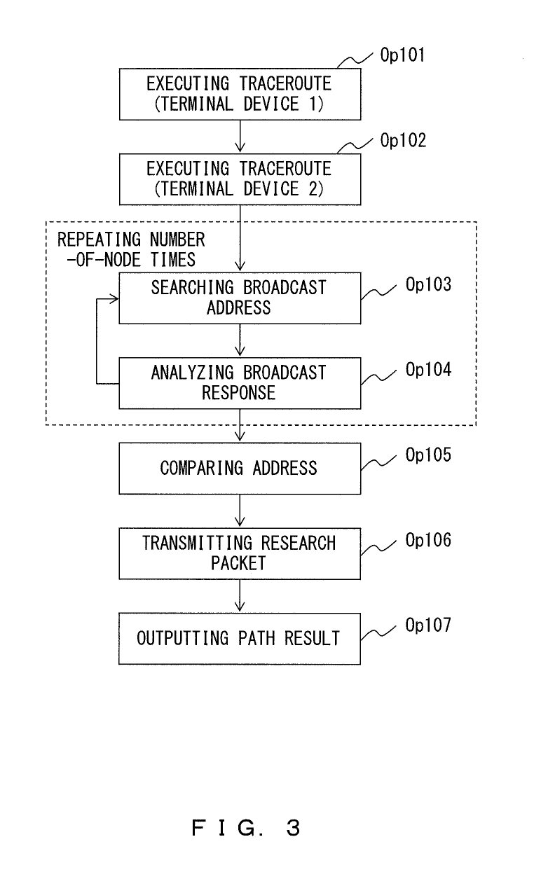

A method for analyzing a path when the terminal 1 communicates with the terminal 2 in the above-described network configuration will be described with reference to FIG. 2 and FIG. 3. FIG. 3 is a flowchart illustrating the operations of the terminal device 1 according to the present embodiment. As illustrated in FIG. 3, firstly, the traceroute processing unit 101 issues a traceroute command from the terminal device 1 to the terminal device 2 (Op101). Moreover, the traceroute processing unit 101 of the terminal device 1 instructs the terminal device 2 to issue by the traceroute processing unit 101 of the terminal device 2 a traceroute command whose destination is the terminal device 1, and receives a response to the traceroute command from the terminal device 2 (Op102).

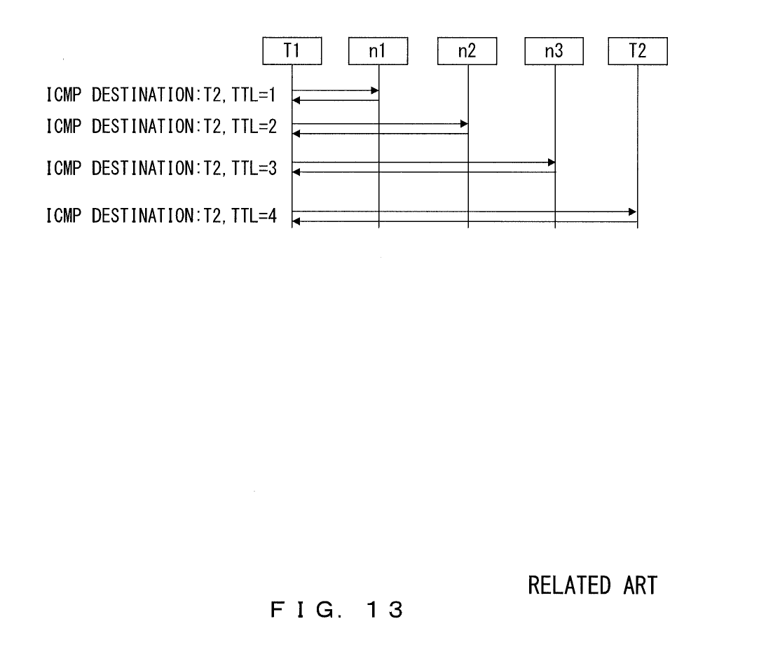

In Op101, the traceroute processing unit 101 of the terminal device 1 repeats issuing of a traceroute command and increases the value of parameter TTL by “1” for each repeat until a response is returned from the terminal device 2, as described with reference to FIG. 13. Accordingly, the traceroute processing unit 101 of the terminal device 1 sequentially receives front addresses from node n1, node n2a, node n3a, and node n4 in the upstream path and the terminal device 2, respectively. In the example of FIG. 2, the front addresses of each relay node (front addresses as viewed from the terminal device 1) obtained in the processing of Op101 are 1.1.1.2 (node n1), 2.2.2.2 (node n2a), 3.3.3.2 (node n3a), and 4.4.4.3 (node n4).

In Op102, the traceroute processing unit 101 of the terminal device 2 repeats issuing of a traceroute command and increases the value of parameter TTL by “1” for each repeat until a response is returned from the terminal device 1. Accordingly, the traceroute processing unit 101 of the terminal device 2 sequentially receives front addresses as viewed from the terminal 2 from the node n4, node n3b, node n2b, and node n1 in the downstream path and the terminal device 1, respectively. In the example of FIG. 2, the front addresses of each relay node (front addresses as viewed from the terminal device 2) obtained in the processing of Op102 are 5.5.5.1 (node n4), 4.4.4.2 (node n3b), 3.3.4.1 (node n2b), and 2.2.2.1 (node n1).

Next, the broadcast processing unit 105 of the terminal device 1 determines a candidate for a broadcast address from each of the relay nodes obtained in the processing of Op101, respectively, and issues a ping command to the determined candidate address (Op103).

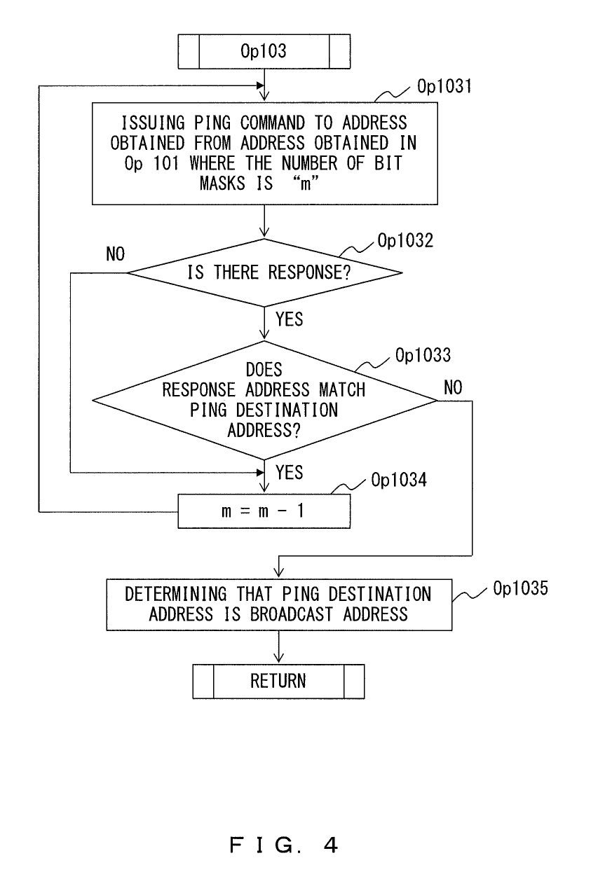

The processing of the broadcast processing unit 105 in Op103 will be described in detail with reference to FIG. 4. As illustrated in FIG. 4, in Op103, the broadcast processing unit 105 issues a ping command to a broadcast address which is obtained from the address obtained in Op101 where the number of bit masks is “m” (Op1031), and sees a response to the issuance of a ping command (Op1032). In Op1031, for example, when finding out a broadcast address for address 2.2.2.2 of the node n2a, firstly, a ping is issued to address 2.2.2.3 which is obtained where the number of bit masks is 30. Although a ping command is used to see a response in the above, any command may be used instead of a ping as long as the command returns some sort of response together with the address information.

In Op1032, if there is no response to a ping command, the broadcast processing unit 105 determines that the address transmitted a ping command in Op1031 is not a broadcast address, and the processing returns to Op1031 with “1” subtracted from the value of “m” (Op1034). For example, if a ping is transmitted to address 2.2.2.3 and there is no response as described above, next, a ping is issued to address 2.2.2.7 which is obtained where the number of bit masks is 29.

When there is a response in Op1032, the address returned in the response is compared with the address from which a ping command is issued in Op1031 (Op1033). When the addresses match as a result of comparison in Op1033, it is determined that the address transmitted a ping command in Op1031 is not a broadcast address, and the processing returns back to Op1031 with “1” subtracted from the value of “m” (Op1034). For example, when a ping command is transmitted to address 2.2.2.7 in Op1031 as described above and the returned address is address 2.2.2.7 in a response, it is determined that the address 2.2.2.7 is not a broadcast address.

On the other hand, when the addresses do not match as a result of the comparison in Op1033, it is determined that the address from which a ping command is issued in Op1031 is a broadcast address (Op1035). For example, if there is a response to a ping issued to address 2.2.2.255 that is obtained by masking 24 bits from address 2.2.2.1 that is different from address 2.2.2.255, it is determined that address 2.2.2.255 is a broadcast address. In the next step, Op104, a response to a ping command from a broadcast address (it is “address 2.2.2.1” in the example above) is used as a broadcast response.

As described above with reference to FIG. 4, once a ping command is transmitted to a candidate for a broadcast address and its response is received in Op103, in the next step of FIG. 3, Op104, the node back-address obtaining unit 102 analyzes a broadcast response obtained in Op103.

A broadcast response is analyzed in Op104 as the node back-address obtaining unit 102 compares a broadcast response with an address obtained due to a traceroute command for a one-hop preceding relay node. Regarding the relationship between a broadcast response and an address obtained due to a traceroute command for a one-hop preceding relay node, there are three kinds of relationship, i.e., the first through third patterns as will be described below.

In the first pattern, a broadcast response does not match an address obtained due to a traceroute command for a one-hop preceding relay node. In this case, it is determined that the back address of a one-hop preceding relay node is returned as a broadcast response. In other words, it is determined that an address obtained due to a traceroute command is a front address of a one-hop preceding relay node, and that the address of a broadcast response is the back address of the relay node. For example, in the network configuration of FIG. 2, if a broadcast response to broadcast address 2.2.2.255 of the node n2a is address 2.2.2.1, it is determined that the front address of the one-hop preceding relay node n1 to the node n2a is “1.1.1.2”, and that the back address is “2.2.2.1”.

In the second pattern, a broadcast response matches an address obtained due to a traceroute command for a one-hop preceding relay node. In this case, it is determined that an address obtained due to a traceroute command is a front address of a one-hop preceding relay node, and that one of the broadcast addresses expressed with a wild card is a back address of the relay node. For example, in the network configuration of FIG. 2, if a broadcast response to broadcast address 3.3.3.255 of the node n3a is address 2.2.2.2, it is determined that the front address of the one-hop preceding relay node n2a to the node n3a is “2.2.2.2”, and that the back address is one of “3.3.3.*” (“*” indicates “1-254”).

In the third pattern, two or more addresses are returned as a broadcast response. In this case, it is determined that an address obtained due to a traceroute command is a front address of a one-hop preceding relay node, and that one of the plurality of addresses returned as a broadcast response is a back address of the relay node. For example, in the network configuration of FIG. 2, if the three addresses “4.4.4.1”, “4.4.4.2”, and “4.4.4.3” are returned as a broadcast response to broadcast address 4.4.4.255 of the node n4, it is determined that the front address of the one-hop preceding relay node n3a to the node n4 is “3.3.3.2”, and that the back address is one of the three addresses mentioned above.

As described above, the back addresses of relay nodes can be obtained in Op104 by the node back-address obtaining unit 102. The obtained back addresses and the front addresses obtained in Op101 and Op102 are temporarily stored in a memory that is accessible by the node back-address obtaining unit 102. At this stage, the back addresses may not always be uniquely determined.

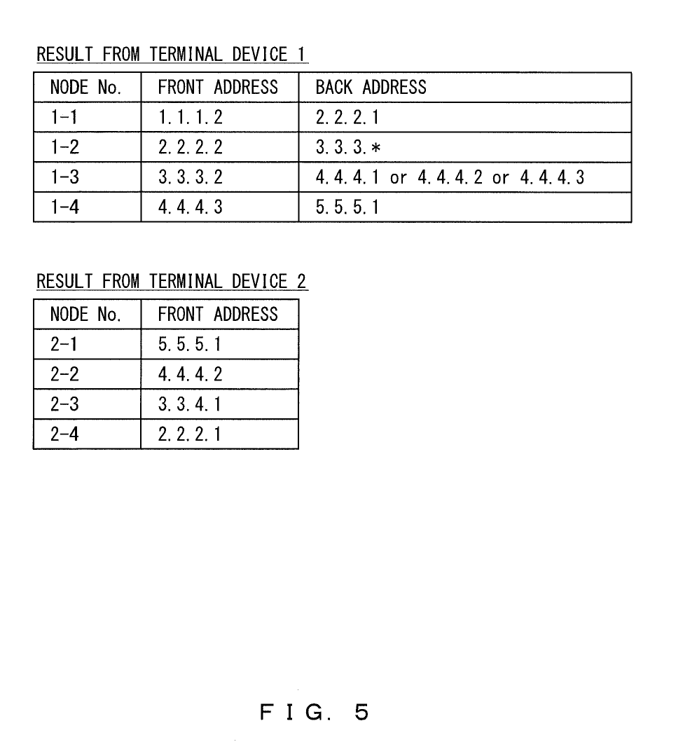

Some specific examples of front addresses and back addresses obtained in the network configuration of FIG. 2 are illustrated in FIG. 5. In FIG. 5, for example, the node depicted as “1-1” is a node whose address is obtained at the first hop (TTL=1) of a traceroute command from the terminal device 1 in the processing of Op101, and the node depicted as “1-2” is a node whose address is obtained at the second hop. Moreover, the node depicted as “2-1” is a node whose address is obtained at the first hop (TTL=1) of a traceroute command from the terminal device 2 in the processing of Op102, and the node depicted as “2-2” is a node whose address is obtained at the second hop.

In other words, at this stage, it is already known due to the processing of Op101 and Op102 that there are four nodes, node 1-1 through node 1-4, in the upstream path between the terminal device 1 and the terminal device 2, and that there are four nodes, node 2-1 through node 2-4, in the downstream path, respectively. However, at this stage, it is not yet known whether or not the nodes of the upstream path and downstream path match.

In Op105, the common-node determination unit 106 compares a back address stored in the above-mentioned memory with a front address obtained in Op101, and thereby determines a match/mismatch between each of the nodes in the upstream path and each of the nodes in the downstream path. In the example of FIG. 5, the node 1-1 (2.2.2.1) completely matches the node 2-4 (2.2.2.1), and thus it is determined that the node 1-1 and the node 2-4 are the same node. It is also determined that there is no node that matches the node 1-2 (3.3.3.*). Regarding the node 1-3 (4.4.4.1, 4.4.4.2, or 4.4.4.3), it is determined that the node 1-3 may match the node 2-2 (4.4.4.2). The node 1-4 (5.5.5.1) completely matches the node 2-1 (5.5.5.1), and thus it is determined that they are the same node. It is also determined that there is no node that matches the node 2-3.

If there is a possibility of matching, as between the node 2-2 and the node 1-3, the common-node determination unit 106 simultaneously issues a command (for example, a ping command) from the terminal device 1 to a possibly matching pair of nodes, and determines whether or not they are the same node depending on whether or not the response times to the commands almost match (Op106). In the example above, the terminal device 1 simultaneously transmits a measure command to the front address of the node 1-3 (3.3.3.2) and the node 2-2 (4.4.4.2) under the control of the common-node determination unit 106, and the if difference in response times is within a specified length of time, it determines that the node 2-2 and the node 1-3 are the same node. By repeating the measurement above several times, it is possible to more precisely determine whether the nodes match. Instead of measuring the response time, it may be configured such that a measure command is simultaneously transmitted to a possibly matching pair of nodes and that each of the nodes is time-stamped, and depending on whether the time difference in the stamped times is within a specified length of time, it is determined whether or not the nodes are the same node. In the case of the node 1-3 and the node 2-2 of FIG. 2, there is a difference exceeding a specified length of time in response times to measuring commands in the processing of Op106, and it is determined that these nodes are not the same node.

In the example of FIG. 2, it is determined in the processing above that the node 1-1 is the same node as the node 2-4 and the node 1-4 is the same node as the node 2-1, and that the other nodes 1-2, 1-3, 2-1, and 2-3 are independent nodes.

The path determination unit 103 determines the network configuration between the terminal device 1 and the terminal device 2 according to a determination result of the common-node determination unit 106. For example, in the specific example of the present embodiment, as illustrated in FIG. 2, it is determined that the route is branched into two routes, the node 1-2 to the node 1-3 and the node 2-2 to the node 2-3, in the network configuration. This determination result is output as a result of analysis in an arbitrary format (Op107).

As described above, according to the configuration of the present embodiment, by issuing a traceroute command from the terminal device 1 and the terminal device 2, respectively, the front addresses of relay nodes on each of a path in the direction from the terminal device 1 to the terminal device 2 and a path in the reverse direction are obtained, and further, the back addresses of the relay nodes are determined by a broadcast response.

In the present embodiment, a path analyzer comprising a path determination unit 103 and a common-node determination unit 106 is described as an example, and the path analyzer is capable of determining an upstream path and a downstream path by using the information of the front address and back address of relay nodes. Having said that, the configuration described herein is just a preferred embodiment, and the path determination unit 103 and the common-node determination unit 106 are not essential elements.

### Second Embodiment

In the second embodiment, a path analysis system capable of quickly obtaining path information when there is quality deterioration in the network will be described. The same reference signs as in the first embodiment will be given to the elements that have a similar function as that of the first embodiment, and detailed descriptions of them will be omitted. Although an IP telephone network is described as an example in the present embodiment, application to the path analysis in server-client systems is also possible.

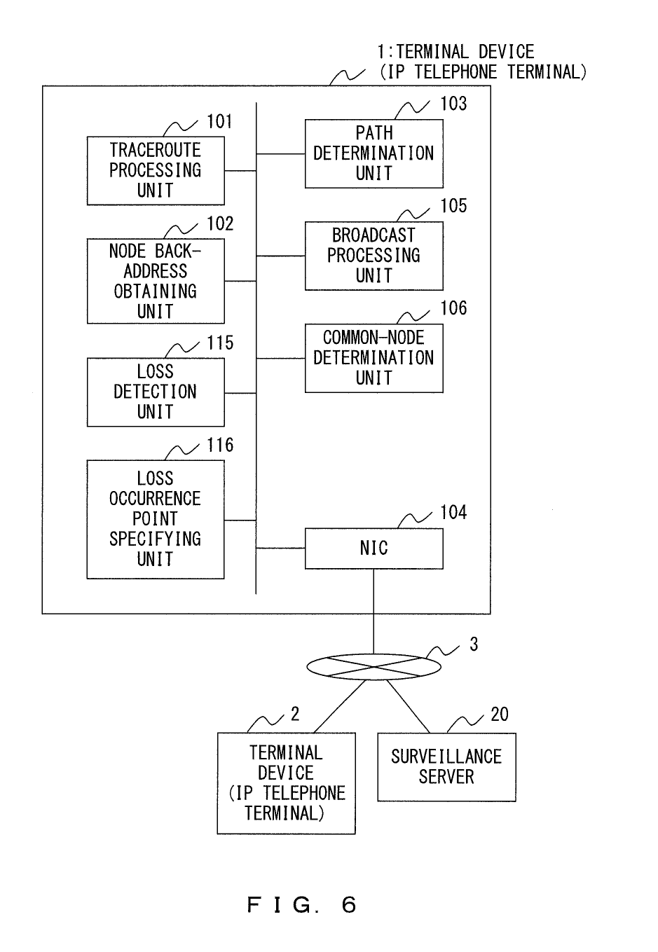

As illustrated in FIG. 6, a path analysis system according to the present embodiment comprises IP telephone terminals as the terminal devices 1 and 2 , wherein each terminal is further provided with at least a packet loss detection unit 115 and a loss occurrence point specifying unit 116. A path analysis system according to the present embodiment is different from that of the first embodiment in the points above. Moreover, an IP telephone network 3 is connected to a surveillance server 20.

The packet loss detection unit 115 detects a packet loss in the IP telephone network. The result detection unit 116 notifies the surveillance server 20 of a result of failure analysis.

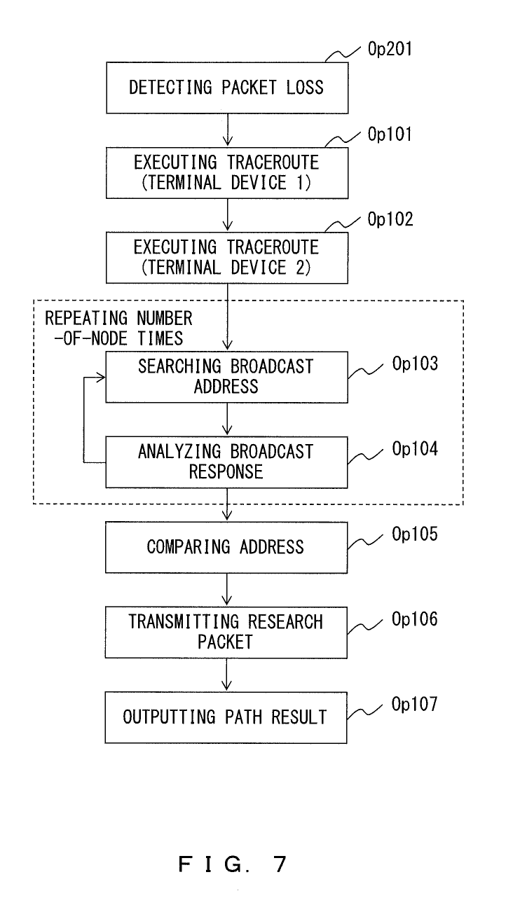

FIG. 7 is a flowchart illustrating the operations of the terminal device 1 according to the present embodiment. As illustrated in FIG. 7, in the operations of a path analysis system according to the present embodiment, a step of detecting a packet loss (Op201) is added on the top of the analysis procedure of the first embodiment. In other words, once a packet loss in the IP telephone network is detected, a path analysis system according to the present embodiment determines the upstream path and downstream path (Op101-Op106) as described with reference to the first embodiment, and then notifies the surveillance server 20 of a result (Op207). It is to be noted that the content of result notification in Op207 is different from that of the first embodiment in Op107. Hereinafter, only the processing of the second embodiment that is different from that of the first embodiment will be described.

First, a method of detecting a packet loss in Op201 will be described. The audio communication in the IP telephone network consists of the packets of an RTP (Real-time Transport Protocol) and an RTCP (RTP Control Protocol). These protocols are defined by IETF RFC3550. An RTP packet is a protocol having a sequence number for every packet, and is constantly transmitted. The terminal device 1 checks whether sequence numbers are consecutive when an RTP packet is received, and thereby detects a packet loss according to a lack of a sequence number. Regarding the packet loss that is transmitted from the terminal device 1, the terminal device 1 is constantly notified, via an RTCP packet, of the information of the number of loss packets that is detected at the time of reception by the terminal on the other end (terminal device 2) according to a lack of a sequence number.

By using such a system of packet loss detection that is generally provided for the IP telephone network, for example the number of transmission losses and the number of reception losses are calculated when an RTCP packet is constantly received, and when there is a loss, it proceeds to Op101 and the following steps in order to search the path at which the loss occurred. The processes of Op101-Op106 are the same as the first embodiment, and thus the description will be omitted.

In Op207, the loss occurrence point specifying unit 116 combines a result of packet loss detection in Op201 and a result of path determination in OP101-Op106 to specify a loss occurrence section, and notifies the surveillance server 20 of the result. For example, it is assumed that the configuration of the IP telephone network including the terminal device 1 and the terminal device 2 is just as illustrated in FIG. 2, and that there are 10 packet losses in the transmission direction from the terminal device 1 to the terminal device 2 and that there is no packet loss in the reception direction. Under these circumstances, the section in the transmission direction 2.2.2.2(3.3.3.1)-4.4.4.1(3.3.3.2) where the path is different between the transmission direction and the reception direction is estimated as a loss occurrence section, and surveillance server 20 is notified of this estimation result. This notification to the surveillance server 20 may be made in any format, such as text message.

As described above, according to the present embodiment, a section at which packet loss occurs is specified by combining the packet loss detection processing and the path analysis processing. Although a packet loss is mentioned as an example of network failure to be detected in the above, the present embodiment may be applied to the anomaly detection of other network parameters (packet transfer delay, or the like).

### Third Embodiment

The third embodiment according to the present invention will be described below. The same reference signs as in the first or second embodiment will be given to the elements that have a similar function as that of the first or second embodiment, and detailed descriptions of them will be omitted.

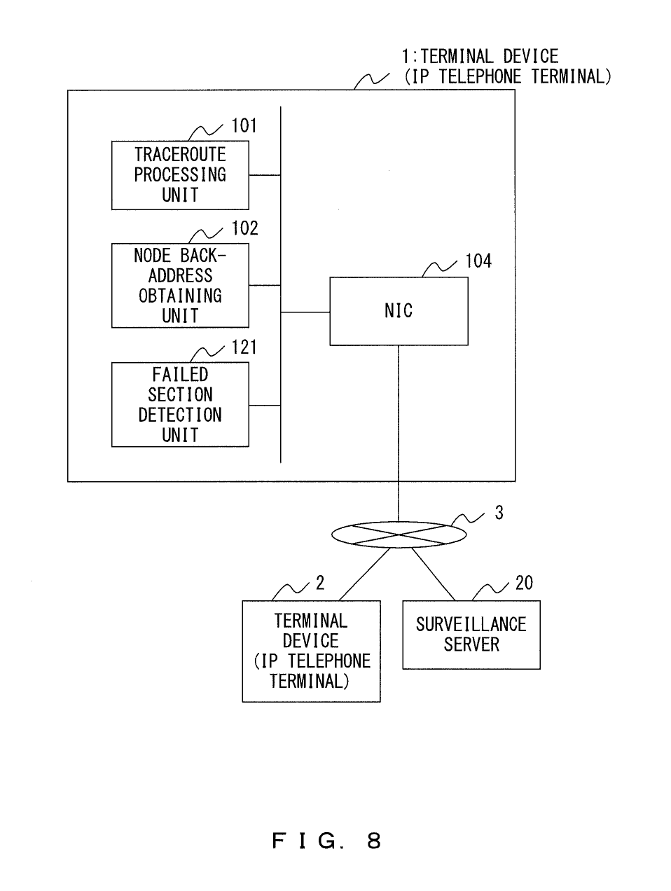

In the present embodiment, after the front address and back address of a relay node are determined as described with reference to the first embodiment, a failed portion such as one having delay failure, disruption, or packet loss is determined by using the determined address information. For this reason, a path analysis system according to the present embodiment is different from the first embodiment in that is comprises a failed section detection unit 121, as illustrated in FIG. 8. It is to be noted that the path determination unit 103, which is mentioned above with reference to the first embodiment, is not included in the example of FIG. 8. In other words, in the configuration of FIG. 8 according to the present embodiment, the path differences between the upstream direction and the downstream direction cannot be detected. However, the path determination unit 103 may be added to the configuration of the present embodiment such that the path differences between the upstream direction and the downstream direction are detectable. Further, the loss detection unit 115 and the loss occurrence point specifying unit 116, which are described with reference to the second embodiment, may be added.

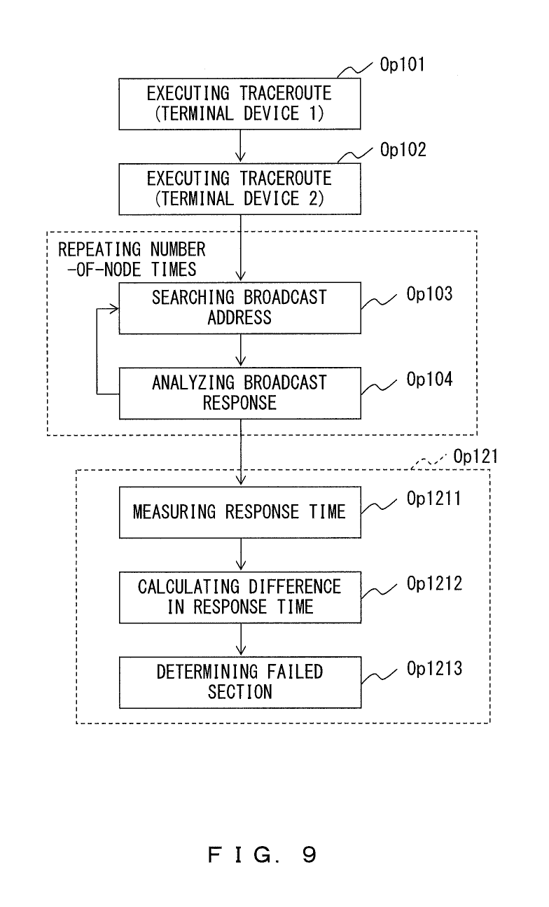

FIG. 9 is a flowchart in which the operations of a path analysis system according to the present embodiment are illustrated. As illustrated in FIG. 9, a path analysis system according to the present embodiment determines the front address and back address in Op101-Op104 as described in the first embodiment, and then performs a failed section detecting step (Op121).

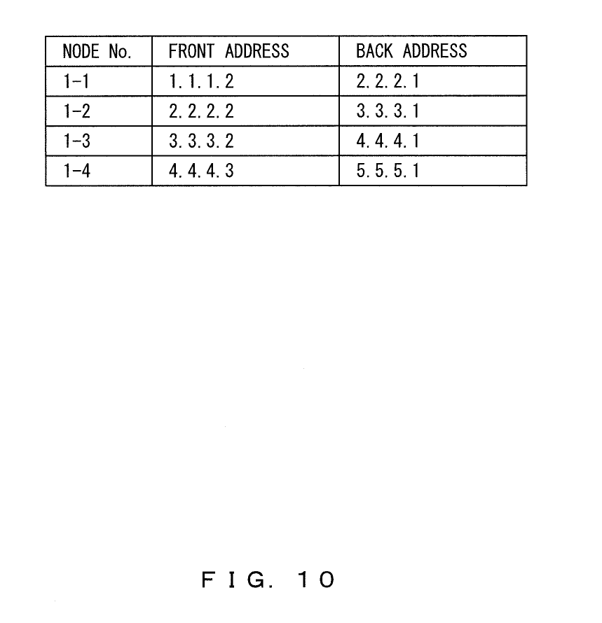

Here, only the processing of the failed section detecting step (Op121) will be described. In the description below, it is assumed that as a result of the processing of path analysis processing (Op101-Op106) described in the first embodiment, the front address and back address of each of relay nodes in the upstream direction from the terminal 1 to the terminal 2 as illustrated in FIG. 2 are obtained as illustrated in FIG. 10.

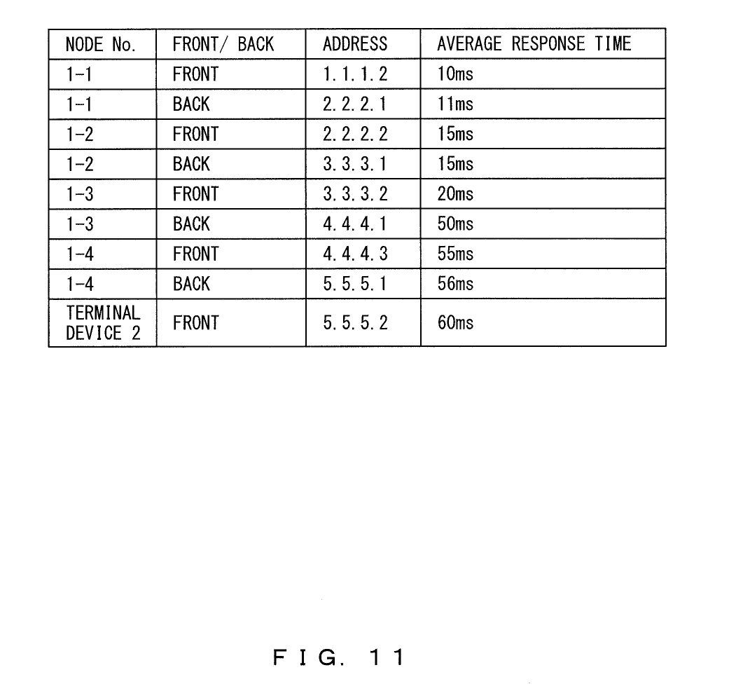

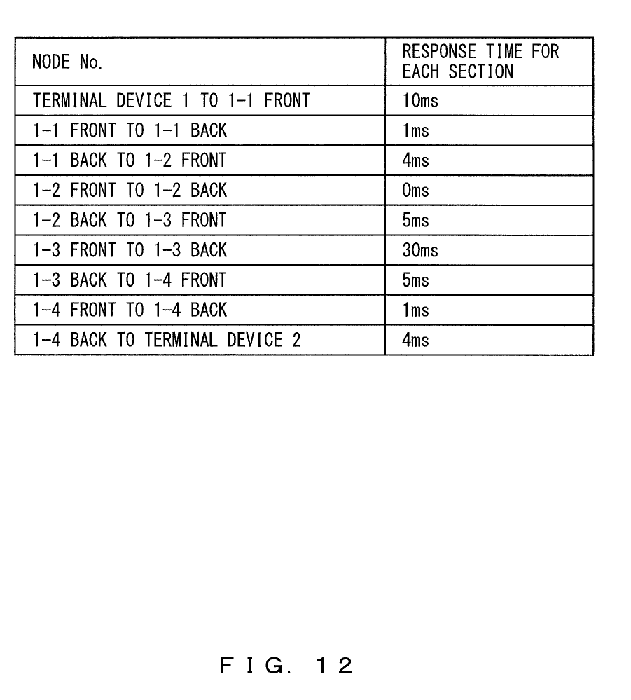

In the failed section detecting step (Op121), firstly, the failed section detection unit 121 transmits a ping command to all the front addresses and back addresses of the relay nodes obtained in the processing of path analysis, and measures the response time (Op1211). It is preferable that the transmission of a ping command and the measurement of response time be repeated to calculate an average value of the response time. Again, it is not limited to a ping command, and any command may be used as long as the response time is measurable. Next, the failed section detection unit 121 calculates the difference in response times between adjacent addresses on a path on the basis of the response time to a ping command each issued to the front address and back address of a relay node (Op1212). The failed section detection unit 121 determines the section in which the delay in response time is largest to be a failed section (Op1213). For example, if it is assumed that the measurement result of response time to each address of FIG. 10 is just as listed in FIG. 11, the differences in response time between the adjacent addresses are just as listed in FIG. 12. In this case, as the delay is largest between the node 1-3 (front side) and the node 1-3 (back side), the failed section detection unit 121 determines that there is a failure in the device of node 1-3.

As described above, according to the present embodiment, by measuring the response time from the front address and back address of a relay node, respectively, not only the failure between nodes, but also the failure within a node is detectable.

According to an aspect of the invention, a path analyzer capable of obtaining the front address and back address of a relay node between terminals in the IP network is industrially applicable.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

1. A path analyzer to obtain an address of a relay node on a path between a first terminal device and a second terminal device, the path analyzer comprising:
a first address obtaining unit to issue a command requiring a response from the first terminal device to the second terminal device, and to obtain as a first address an address of a first terminal device side in the relay node on the path according to a response to the command;
a broadcast processing unit to search a candidate address for a broadcast address from the relay node according to the first address obtained by the first address obtaining unit, and to issue a command requiring a response from the first terminal device to the candidate address; and
a second address obtaining unit to obtain as a second address an address of a second terminal device side in the relay node on the path according to a response to the command issued by the broadcast processing unit.

2. The path analyzer according to claim 1, further comprising a failed section detection unit to issue a command requiring a response to the first address obtained by the first address obtaining unit and to the second address obtained by the second address obtaining unit, respectively, and to calculate a difference in response time to the command for a combination of two addresses neighboring on the path from among the first and second addresses, and to determine that a failure has been caused between two addresses in a combination from which a largest difference is calculated.

3. The path analyzer according to claim 1, further comprising:
a third address obtaining unit to issue a command requiring a response from the second terminal device to the first terminal device, and to obtain as a third address an address of a second terminal device side in the relay node on a path from the first terminal device to the second terminal device according to a response to the command;
a common-node determination unit to compare the second address obtained by the second address obtaining unit with the third address obtained by the third address obtaining unit, and to determine a common relay node between a path from the first terminal device to the second terminal device and a path from the second terminal device to the first terminal device; and
a path determination unit to determine a section passing through mutually different relay nodes between a path from the first terminal device to the second terminal device and a path from the second terminal device to the first terminal device according to a determination result of the common-node determination unit.

4. The path analyzer according to claim 3, further comprising a failed section detection unit to issue a command requiring a response to the first address obtained by the first address obtaining unit and to the second address obtained by the second address obtaining unit, respectively, and to calculate a difference in response time to the command for a combination of two addresses neighboring on the path from among the first and second addresses, and to determine that a failure has been caused between two addresses in a combination from which a largest difference is calculated.

5. The path analyzer according to claim 3, further comprising:
a network failure detection unit to detect that a network failure has been caused between the first terminal device and the second terminal device; and
a network failure occurrence portion specifying unit to determine that a network failure has been caused at a section determined by the path determination unit as the section passing through mutually different relay nodes when the network failure detection unit detects that a network failure has been caused in either communication from the first terminal device to the second terminal device or communication from the second terminal device to the first terminal device.

6. The path analyzer according to claim 5, further comprising a failed section detection unit to issue a command requiring a response to the first address obtained by the first address obtaining unit and to the second address obtained by the second address obtaining unit, respectively, and to calculate a difference in response time to the command for a combination of two addresses neighboring on the path from among the first and second addresses, and to determine that a failure has been caused between two addresses in a combination from which a largest difference is calculated.

7. The path analyzer according to claim 3, wherein
the common-node determination unit simultaneously issues a command requiring a response to each of two addresses which belong to a combination estimated to be addresses of a same node from among combinations of the second address and the third address, and determines whether or not the two addresses are addresses of a same node according to a status of a response to the command.

8. The path analyzer according to claim 6, further comprising a failed section detection unit to issue a command requiring a response to the first address obtained by the first address obtaining unit and to the second address obtained by the second address obtaining unit, respectively, and to calculate a difference in response time to the command for a combination of two addresses neighboring on the path from among the first and second addresses, and to determine that a failure has been caused between two addresses in a combination from which a largest difference is calculated.

9. The path analyzer according to claim 6, further comprising:
a network failure detection unit to detect that a network failure has been caused between the first terminal device and the second terminal device; and
a network failure occurrence portion specifying unit to determine that a network failure has been caused at a section determined by the path determination unit as the section passing through mutually different relay nodes when the network failure detection unit detects that a network failure has been caused in either communication from the first terminal device to the second terminal device or communication from the second terminal device to the first terminal device.

10. The path analyzer according to claim 9, further comprising a failed section detection unit to issue a command requiring a response to the first address obtained by the first address obtaining unit and to the second address obtained by the second address obtaining unit, respectively, and to calculate a difference in response time to the command for a combination of two addresses neighboring on the path from among the first and second addresses, and to determine that a failure has been caused between two addresses in a combination from which a largest difference is calculated.

11. A program executed by a computer to perform path analysis to obtain an address of a relay node on a path between a first terminal device and a second terminal device, the path analysis comprising:
a first address obtaining process to issue a command requiring a response from the first terminal device to the second terminal device, and to obtain as a first address an address of a first terminal device side in the relay node on the path according to a response to the command;
a broadcasting process to search a candidate address for a broadcast address from the relay node according to the first address obtained in the first address obtaining process, and to issue a command requiring a response from the first terminal device to the candidate address; and
a second address obtaining process to obtain as a second address an address of a second terminal device side in the relay node on the path according to a response to the command issued in the broadcasting process.

12. A method for analyzing a path which is achieved by directing a computer to perform path analysis to obtain an address of a relay node on a path between a first terminal device and a second terminal device, the method comprising:
a first address obtaining process to issue a command requiring a response from the first terminal device to the second terminal device, and to obtain as a first address an address of a first terminal device side in the relay node on the path according to a response to the command;
a broadcasting process to search a candidate address for a broadcast address from the relay node according to the first address obtained in the first address obtaining process, and to issue a command requiring a response from the first terminal device to the candidate address; and
a second address obtaining process to obtain as a second address an address of a second terminal device side in the relay node on the path according to a response to the command issued in the broadcasting process.

13. The path analyzer according to claim 7, further comprising a failed section detection unit to issue a command requiring a response to the first address obtained by the first address obtaining unit and to the second address obtained by the second address obtaining unit, respectively, and to calculate a difference in response time to the command for a combination of two addresses neighboring on the path from among the first and second addresses, and to determine that a failure has been caused between two addresses in a combination from which a largest difference is calculated.
